(19) United States
(12) Patent Application Publication
(10) Pub. No.: US 2005/0120009 A1
(43) Pub. Date: Jun. 2, 2005

(54) System, method and computer program application for transforming unstructured text

(76) Inventor: J. Brooke Aker, West Hartford, CT (US)

Correspondence Address: Attn: Anita Lomartra;McCARTER & ENGLISH, LLP, CityPlace I, 185 Asylum Street, Hartford, CT, 06103, US

(21) Appl. No.: 10/992,586

(22) Filed: Nov. 18, 2004

Related U.S. Application Data
(60) Provisional application No. 60/524,274, filed on Nov. 21, 2003.

(51) Int. Cl. G06F 7/00

(52) U.S. Cl. 707/3

(57) ABSTRACT

A system, method and computer program application for finding relevant information from a plurality of sources including unstructured sources, mining the relevant information and generating output based upon the relevant information. The system, method and computer program application may be effectively utilized to more efficiently accomplish a variety of different business related tasks. A business that takes advantage of the system, method and computer program application receives a number of advantages, including (i) universal searching, (ii) efficient business event intelligence gathering; (iii) effective business event analyzing; and (iv) automated and streamlined up-to-date reporting.

### CROSS-REFERENCE TO RELATED APPLICATION

The present application claims the benefit of a provisional application entitled “System and Method for Transforming Unstructured Text” which was filed with the U.S. Patent Office on Nov. 21, 2003 and assigned Ser. No. 60/524,274. The entire contents of the foregoing provisional patent application are hereby incorporated by reference.

### BACKGROUND OF THE INVENTIONS

1. Technical Field

The present disclosure relates to systems, methods and computer program applications for using information. More particularly, the present disclosure relates to an improved system, method and computer program product for gathering, organizing and presenting information to allow efficient review and use.

2. Background of the Invention

Modern workers, professional individuals, and the like have an unprecedented ability to access information. Frequently, the success of these individuals relies on their ability to effectively process the large amounts of available information. Often, when collecting information analysis in support of making a decision, so many documents are available that the typical individual and/or staff cannot effectively and/or accurately review everything. Typically, these documents are in unmanageable formats that prevent reformatting. Moreover, modern searching methods, such as search engines used on the Internet, yield many irrelevant documents. Drawbacks of these types extend across many platforms and business areas such as information technology, law, healthcare and others.

Accordingly, there is a need for a system, method, and computer program application for searching available information sources, which includes unstructured text sources of information, interpreting and/or analyzing information contents, and presenting relevant information to the user.

### SUMMARY OF THE INVENTION

The present disclosure provides a system, method and computer program that overcomes many of the prior art problems associated with gathering, sorting and using information, and more particularly unstructured information. The present disclosure is directed to an exemplary system, method and computer program application whose contents cause a computer system to perform a method for transforming unstructured text.

A system for transforming unstructured text, according to an exemplary embodiment of the present disclosure, includes (i) means for defining a search query, (ii) means for searching a plurality of information sources so as to collect data relevant to the search query, (iii) means for processing the collected data so as to identify and transform unstructured text into structured text, (iv) means for reporting results to an end user, and (v) means for storing results for reuse.

In another exemplary embodiment of the present disclosure, a method for performing event analysis is provided including the steps of: (i) defining at least one event (e.g., a business related event), (ii) searching a plurality of information sources including unstructured text sources, (iii) collecting data from said information sources, (iv) processing said collected data using a plurality of passes, (v) identifying occurrences of said event, (vi) analyzing identified occurrences of said event, and (vii) generating output based on relevant information pertaining to said event. Advantageously, the information sources include public, semi-public and private sources. In addition, the processing passes are selected from a group consisting of tokenizing, initializing, converting sub-trees to prose-like strings, resolving company names, setting XML tags, tagging white spaces, setting regions, marking HTML tags, removing HTML tags, identifying entities, tokenizing domains, reducing text, marking common entities, converting time, marking common words, converting numbers, recognizing simple business events, marking copyrights, marking headlines, extracting business entities, revising the knowledge base, generating and unifying metadata, categorizing companies, building causal phrases, correcting abbreviations, preparing event sentences, categorizing events, sub-segmenting information into output chosen by an end user, outputting a report to XML, and consuming XML.

According to still another exemplary embodiment of the present disclosure, a computer program application for advantageously causing a computer system to perform a method for transforming unstructured text is provided. The application includes (i) an identifying feature for finding one or more defined events in various sources of information, (ii) an analyzing feature for analyzing identified events so as to filter out extraneous information, (iii) a transforming feature for reducing any form of text in any sentence structure to subject-verb-object, and (iv) an output feature for outputting the identified events in a manner prescribed by an end user.

A beneficial feature provided by the computer program application of the present disclosure is found in its utility in predicting an event. That is, in accordance with another exemplary embodiment of the present disclosure, a method for predicting an event is provided including the steps of: (i) inputting a query so as to defining at least one event, (ii) conducting a search among a number of different information sources, (iii) collecting data from the information sources, (iv) providing the resulting data to the computer program application of the present disclosure, which employs computational linguistics to identify subject-verb-object in any form of text in any sentence construction, (v) analyzing the data via a plurality of passes so as to identify relevant information and transform the relevant information into a raw text format, and (vi) exporting the relevant information to a database so as to be usable as input for a discrete choice probability model for predicting the probability of the event.

It should be appreciated that the system, method and computer program application of the present disclosure can be implemented and utilized in numerous ways, including without limitation as a process, an apparatus, and/or a device for applications now known and later developed. These and other features, advantages and benefits of the disclosed system, method and computer program application will be apparent from the detailed description which follows, particularly when reviewed in conjunction with the figures appended hereto.

### BRIEF DESCRIPTION OF THE FIGURES

To assist those of skill in the art to which the subject matter of the present disclosure appertains to make and use the disclosed system, method and computer program application, reference is made to the accompanying figures, wherein:

FIG. 1 is an overview of an environment in which an exemplary embodiment of the system, method and/or computer program application of the present disclosure may be used;

FIG. 2 is a layered architecture of an exemplary embodiment in accordance with the present disclosure;

FIG. 3 is a block diagram of the components of a system in accordance with another illustrative embodiment of the present disclosure;

FIG. 4 is a simplified diagram of the feature components of a computer program application according to an illustrative embodiment of the present disclosure;

FIG. 5 is flowchart diagram providing an overview of an exemplary text processing operation in accordance with an illustrative aspect of the present disclosure;

FIG. 6 is a graphical representation of a probability model for predicting a business related event according to an illustrative aspect of the present disclosure;

FIG. 7 is a flowchart diagram according to an exemplary utilization of the probability model of FIG. 6 for predicting a business related event according to an illustrative aspect of the present disclosure;

FIG. 8 is an exemplary architecture view illustrating an implementation of the predictive functionality according to an illustrative aspect of the present disclosure;

FIG. 9 is an exemplary user interface input screen according to the present disclosure;

FIG. 10 is a screenshot of an exemplary input/output screen according to the present disclosure;

FIG. 11 is a screenshot of an exemplary output screen in accordance with the present disclosure;

FIG. 12 is a screenshot of another exemplary output screen according to the present disclosure;

FIG. 13 is another exemplary output according to the present disclosure;

FIG. 14 is another illustrative screenshot of an exemplary input/output screen according to the present disclosure;

FIG. 15 is still another exemplary output according to the present disclosure;

FIG. 16 is still another illustrative screenshot of an exemplary input/output screen according to the present disclosure;

FIG. 17 is yet another illustrative screenshot of an exemplary input/output screen according to the present disclosure; and

FIGS. 18 to 25 are still further exemplary outputs according to other illustrative aspects of the present disclosure.

### DETAILED DESCRIPTION OF EXEMPLARY EMBODIMENT(S)

As noted above, the present disclosure is directed to an exemplary system, method and computer program that may be used to gather, sort and use unstructured information. The advantages, and other features associated with the exemplary system, method and computer program disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

For the purpose of explanation rather than limitation, specific details are set forth such as the particular environment, architecture, interfaces, techniques, etc., in an effort to provide a thorough understanding of the present invention. For purposes of simplicity and clarity, detailed descriptions of well-known devices, circuits and methods have been omitted.

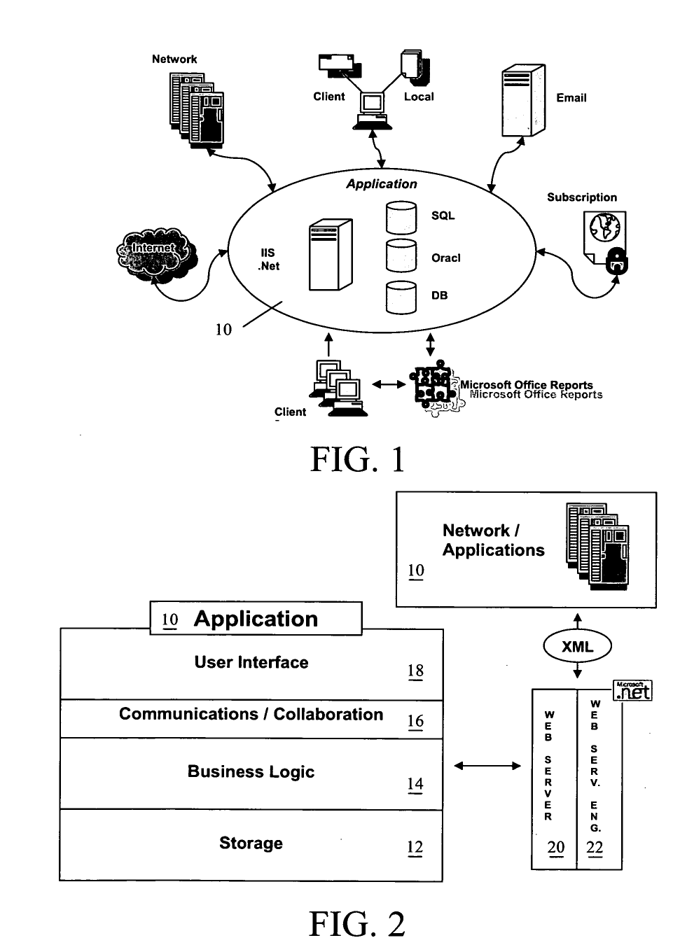

Referring to FIG. 1, there is shown an overview of an exemplary client/server environment in which one or more client work stations or computers are utilized to access an application 10 hosted on a server, for example. While the client computers of FIG. 1 are of general purpose, it will be appreciated that custom hardware and/or software also may be employed for the purpose of implementing different operative aspects of the present disclosure. As shown, the application 10 is operatively connected to public sources, e.g., via the Internet, semi-public sources, e.g., via subscription services, and private sources, e.g., via internal e-mail, hard-drive, network, applications, databases and the like.

Referring to FIG. 2, there is shown a layered architecture in accordance with an illustrative aspect of the present disclosure. As shown, a storage layer 12, a logic layer 14, a communications/collaboration layer 16, and a user interface layer 18 are operatively associated with a web server 20 and a web service engine 22. The web server 20 and web service engine 22 are, in turn, operatively associated with auxiliary network applications 24 and the application 10 is integrally associated with the user interface layer 18.

The environment and architecture of FIGS. 1 and 2 preferably make use of computer systems that include at least means for processing information, means for storing static and/or dynamic information, means for communicating and/or receiving information, a user input interface, and an operating system for controlling the allocation of system resources and performing tasks, such as processing, scheduling, memory management, networking, and I/O services, among other things. It should be understood that other processing systems equally may be used, including systems having architecture dissimilar, at least in part, to that which is shown in FIGS. 1 and 2. In addition, it should be noted that client computers within the context of the present disclosure includes, but is not limited to, laptop computers, mobile phones, and other mobile computing devices, such as personal digital assistants (PDAs), personal communication assistants (PCAs), electronic organizers, interactive TV/set-top box remote control, or any duplex interactive devices capable of Internet access.

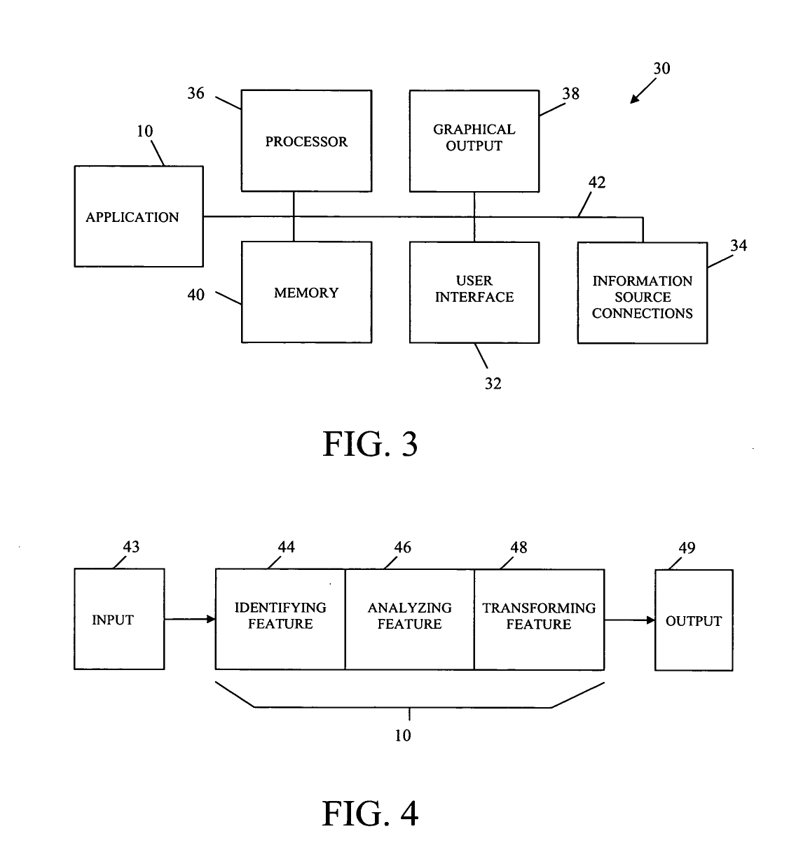

Referring to FIG. 3, there is shown an exemplary embodiment of the present invention which includes a system 30 having a user interface 32 enabling a user to define a search query, one or more public, semi-public and/or private information source connections 34 (e.g., databases, networks, Internet, etc.) to collect data relevant to a search query, a processor 36 for processing the collected data so as to, among other things, identify and transform unstructured text into structured text, a graphical output 38 (e.g., a display) for presenting results to the user, a memory 40 for storing results for reuse, and a bus 42 or other communication means facilitating communication by and between the various components of the system 30.

In operation, the application 10 directs the processor 36 to search and collect information form the various information sources, then identify and interpret the collected data and impose structure on data that is otherwise unstructured. In the search mode, the user inputs one or more queries via the user interface 32 to access relevant information from the information sources. The inputting of a query may be accomplished in different ways. For example, in a preferred aspect of the present disclosure, the user may use a pointing device (e.g., a keyboard or mouse) to select predefined searching parameters. In alternative aspects of the present disclosure, the searching parameters are defined by the user and/or can be indirectly (e.g., voice recognition) entered via the user interface 32. A search engine or browser conducts a federated search identifying and collecting information related to the query and any unstructured text is transformed to structured text so as to be more effectively utilized. More about the text transformation feature will be discussed hereinafter.

In a preferred aspect of the present disclosure, the application 10 is implemented as a computer program, executable within a computer system. The computer program (or computer control logic) of the present disclosure, when executed, enables the computer system to perform at least the above-discussed operations. FIG. 4 schematically illustrates the preferred features of the computer program, which include an identifying feature 44, an analyzing feature 46 and a transforming feature 48. The identifying feature 44 finds one or more defined events in various sources of information 43 (e.g., web pages, news, e-mails, network, etc.). Once the events are identified, which events are defined via text, the analyzing feature 46 analyzes the results filtering out extraneous information and the transforming feature 48 reduces any form of text in any sentence structure to subject-verb-object (SVO). After the events have been identified, interpreted and transformed as appropriate, such events can be counted, graphed, charted, modeled, predicted and/or otherwise quantified or manipulated so as to enable the user to obtain any of a variety of different outputs 49, as desired.

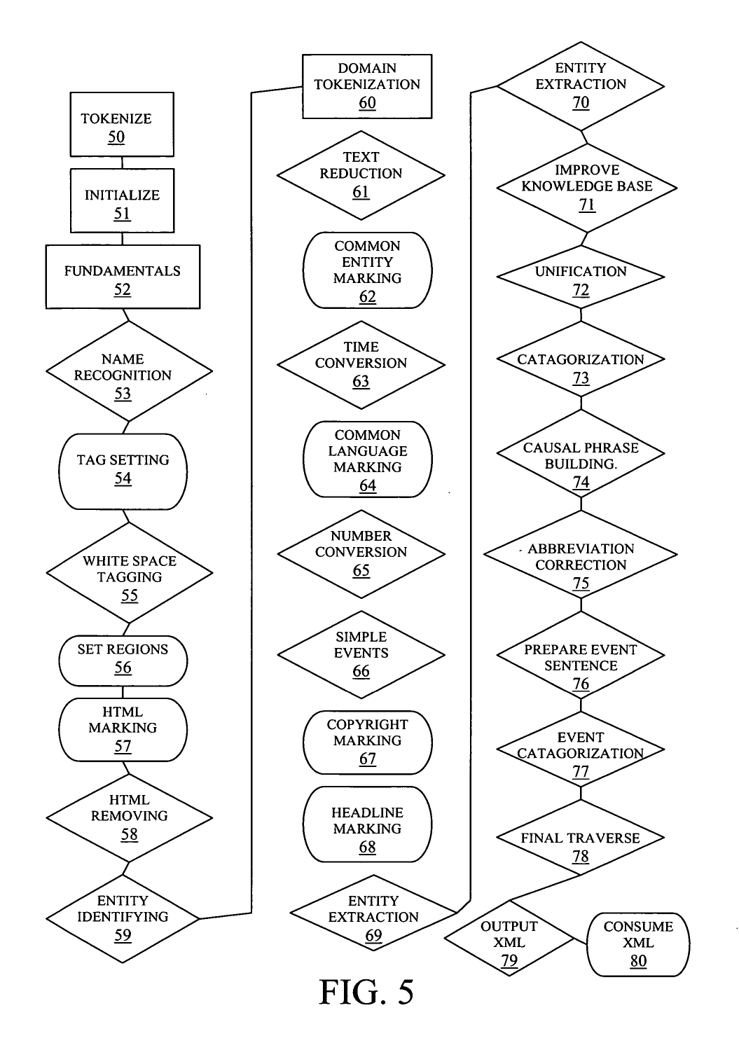

FIG. 5 is a flow chart illustrating the operation steps or transformation passes that are incorporated in the software application 10 according to a preferred aspect of the present disclosure. Although the events in this illustration are defined as business events, one skilled in the pertinent art will appreciate from the present disclosure that any of a variety of other event types equally may defined and/or used. The analyzing sequence is a series of steps or passes, each containing its own pass algorithm. As the analyzer is run over the text, each pass is taken in the order it occurs in the sequence and executes the code and rules that are contained in it. The rectangle elements represent a state, the oval elements represent tags, the diamond elements represent transform, and the octagon elements represent consume.

The first step or pass 50 in the analyzer sequence is tokenize by default, which is a system pass that converts the input text to a parse tree. The parse tree converts the text into a common structure so that later passes can work more efficiently with the text.

An initialize pass 51 sets external parameters such file types and locations for input to the analyzer as well as output types and locations as XML, relational databases and meta information. The initialize pass 51 also makes a connection to a knowledge base containing common and custom terms, proper nouns, names and other information specific to the end user. Subsequent passes can then update the knowledge base to improve the accuracy and efficiency thereof.

A fundamentals pass 52 converts sub-trees to prose-like strings, as in, for example, “IBM buys Lotus” to contain concepts. Finds and marks spaces and punctuation to know where sentences begin and end. The fundamental pass 52 also converts months to numbers (e.g., Jan. . . . Dec. to 1 . . . 12, respectively) for later classifying or filtering with more efficiency.

A name recognition pass 53 finds and resolves formal names in the text. In the present embodiment, this involves locating business names by, for example, identifying capitalizations, proper nouns or other business designators (e.g., Inc., LLP, LLC, PC, Co., etc.). Matching company names in the knowledge base is also accomplished by this pass. The name recognition pass 53 will increase references to names if new and register in the knowledge base for increased accuracy, as is “IBM” also is the same as “IBM, Inc.”, “International Business Machines”, etc.

A tag setting pass 54 adds tags to resolved company names for later output. The tags preferably adhere to XML standards for consumption by graphics programs outside of the application 10. This pass is the first cut at identifying full concept business events under the hypothesis that companies as entities take action that affects others. Subsequent passes will identify the actions and then group the actions into categories.

A white space tagging pass 55 identifies non-essential marks such as dashes, commas, etc. that do not convey information for the purposes of the application 10. Once these non-essential marks are tagged no further processing of theses text characters is necessary and thus processing time is saved.

A region setting pass 56 works to identify the main body of the text relative to other text. For example, in web pages, this means finding the central region body text and not sidebars. In news articles, it means finding the central region body text and not publisher or declaratory statements such as company or individual backgrounds or explanations.

Having identified the main body text, an HTML marking pass 57 operates to find web page HTML anchors so as to keep track of the main body text for processing. The HTML marking pass 57 also delineates HTML style tags for exclusion as HTML style tags do not cover information but are only about presentation. With areas marked for processing unnecessary and confusing HTML tags (e.g., the extraneous HTML style tags) can be removed by a HTML tag removing pass 58. The application 10 efficiency is further improved by not processing text that provides no relevant information.

An entity identifying pass 59 through the entire text operates to identify other entities (e.g., stock exchanges, regulatory bodies, etc.). Such entities may be specified in a variety of forms (e.g., acronym or spelled out). For example, the “New York Stock Exchange” may equally be specified as “NYSE”. The entity identifying pass 59 is preferably able to determine whether the entity is a subject (an entity taking action) or an object (an entity on which an action was intended to affect). The entity identifying pass 59 also operates to resolve entities with the knowledge base and adds to the knowledge base as appropriate any new information.

A domain tokenization pass 60 operates to pick up industry, source author and/or date range end user cues to form domains. For example, a company such as “Johnson & Johnson” can be in the industry domain “Pharmaceutical” as well as in the domain “Consumer Products” since the company makes products that fall within both industries. Source and author information provides cues for the quality of information. For example, a page from the “Wall Street Journal” would have a higher factual confidence rating than a web page of chat.

A text reduction pass 61 operates to reduce the overall size of the text to be processed for greater efficiency. The text reduction pass 61 prevents any extraneous text identified in any of the previous passes, and particularly, in the white space tagging pass 55, the HTML tag removing pass 58, and/or the domain tokenization pass 60 so as to provide improved processing efficiency.

Using the knowledge base and cues such as capitals, periods and the number of characters allows for a common entity marking pass 62 to find and mark common entities such as countries, cities, postal codes, days, years, etc. The common entity marking pass 62 enables an analytical use of business events to be sorted, for example, by geography and/or time.

A time conversion pass 63 operates to find all forms of date and times and converts them to common number form for use in a relational database. For example, MM/DD/YY may also be expressed MM/DD/YYYY or in the European version of dates YY(YY)/MM/DD, MM/DD/YYYY, etc. This pass facilitates organizing business events by time.

A common language marking pass 64 operates to find a number of common language words or terms. For example, in the English language terms like “it, and, the, they, them”, etc. are marked relying on an extensive set of such terms found in the knowledge base, which is updated as appropriate. A recursive portion of the common language marking pass 64 is used to determine if a preposition refers to a subject (e.g., a company) or an object (e.g., a focus of an action).

A number conversion pass 65 finds and converts to common basic all numerical references as in integers, thousands, millions, billions, etc. These numerical references can include contextual identifiers such as monetary symbols (e.g., $), percentages (e.g., %) or other unit symbols (e.g., 000's, m, b etc.). The common basic conversion may include division or multiplication so that filtering or sub-segmenting in the relational database can be done with accuracy and without delay.

A simple event pass 66 takes a first quick pass at simple events that are quite common (e.g., sell, buy, merge, launch, advertise, hire, fire, etc.) and variations on these events as identified in the knowledge base. If the event is in the same sentence as an identified company the sentence is marked for further processing towards an export of the full concept event.

A copyright marking pass 67 operates to find and mark copyright instructions or identifiers so as to allow end users to adhere to legal and/or contractual use of materials public or private, internal or external during processing.

A headline marking pass 68 uses a number of techniques to find and mark headlines or lead ideas in text. These techniques include identifying HTML tags that directly contain a headline and/or employing a technique that relies on how business content is typically written. For example, the technique can look at text taking as a default that first and last paragraphs are more important than all others, and that first and last sentences per paragraph are more important than all others. A headline summary or other general idea version of the information can thus be generated via the content-construction technique.

Having identified companies in prior passes, an entity extraction pass 69 operates to find and mark, for example, company products, executives, or locations. These may be the objects to which the subjects address their actions but they may also be the context or focus of the actions or events under examination. For instance, the text “IBM buys Lotus for its Notes software”, has the subject IBM taking the event buy on the object Lotus with a focus or context on “Notes software” (i.e., the reason IBM bought Lotus). The use of these entities is in sub-segmenting or further contextualizing captured business events.

An improve knowledge base pass 70 is used to make improvements in the knowledge base after all entities have been identified. With companies, executives, products, source, time, and geography identified, matching and variation improvements to the knowledge base are completed as appropriate.

A unification pass 71 is needed since the present algorithm is working across heterogeneous sources of information (e.g., web pages, news articles, emails, etc.), identification, and unification and if necessary unification of meta information is needed, including information about author, source, publication date, etc. For example, with respect to web pages, which often do not include a publication date but rather only reflect the date the reader reviews the material, the unification pass 72 identifies cues that can be found in the text body that allow a publication date to be determined with a fair degree of accuracy. For instance, if the text mentions an event in the “1^{st} quarter” a publication date of February 15^{th} can be used as a reasonable estimate. The more cues provided in the text, the better the estimation.

A categorization pass 73 operates to collect identified companies and variation of companies into common groups. For example, a common group of pharmaceutical companies such as Merck, Amgen and Roche may be the buyers of a common group of suppliers of industrial gases as in Air Products and Air L'Quide. The categories established via the categorization pass 73 help to refine the directional relationship in the particular business environment under examination.

A causal phrase building pass 74 matches companies and events to company categories providing in a stepwise build towards the goal of capturing sentences that answer “who did what to whom”. The causal phrasing puts the final identification on the event (i.e., who is the subject and who is the object).

An abbreviation correction pass 75 is a recursive pass to capture and correct for company name abbreviations and match events again. The abbreviation correction pass 75 operates recursively by finding events first and locating the subject and checking if it is a new abbreviation or company. The abbreviation correction pass 75 adds new company events to categories. For example, if an event for “International Business Machines” was previously identified but “IBM” was missed as the abbreviation for this company, the abbreviation correction pass 75 may find the event “buy” and note the subject “IBM” matching it to “International Business Machines” in the knowledge base.

Once a full event is prepared with subject, event and object identified, a prepare event sentence pass 76 is employed to prepare the sentence and its identifiers in an XML format for consumption outside of the application 10 as, for example, in a graphics program and/or a relational database. It is noted that source, dates, author, time, and/or geography identifiers may also be present as appropriate.

An event categorization pass 77 operates to collect and count all events. Statistical processing and generation then follows. For example, means, modes and standard deviations among any selected group of companies and/or events allows for testing a hypothesis for level of effort in a market place between selected companies by focusing on the number of standard deviations above or below the mean for each company. Testing results can be reported or represented in a graphical manner, for example.

A final traverse pass 78 of the text is performed to sub-segment into user selected output. For example, if the user caress only about events to do with “mergers and acquisitions”, these types of events are identified and output as specified by the user while other events in the text such as events concerning financial reporting, are not identified and/or reported to the user.

An output to XML pass 79 writes out in XML format the desired companies, events, categories, dates, sources, author, etc. and full sentences for consumption by graphics routines. A consume XML pass 80 can then call various graphic routines to “see” events tabled by event categories and/or companies, by time, by source, and/or any of a variety of other parameters including statistically generated parameters or tests using the XML output provided by the output to XML pass79.

The various passes identified and described hereinabove may be implemented by programming them into functions incorporated within application programs, and programmers of ordinary skill in the pertinent art based on the teachings herein can implement such operations using customary programming techniques in languages such as, for example, C, Visual Basic, Java, Perl, C++, and the like.

As is apparent from the foregoing, the present disclosure provides, in part, for a computer program application to accomplish, among other things, collecting, processing and presenting a large amount of unstructured information so that an end user associated with a client computer can quickly and efficiently monitor and/or utilize a business related event. In addition, the software program of the present disclosure is preferably capable of eliminating duplicative information by, for example, comparing URL sources, employing pattern matching techniques, and/or utilizing date matching methods.

The end user may customize the event, entity, subject matter, combinations thereof and the like that are of interest and the knowledge base for interpreting the information may be built up from various public, semi-public and/or private sources. An example of a public source is WORDNET® available from Princeton University of Princeton, N.J. Additional examples of public sources include, the Internet (e.g., Google®, Yahoo®), news and PR (e.g., Google News®), science (e.g., Scientific America®), legal (e.g., FindLaw®), government (e.g., Patent & Trademark Office, Department of Defense), and/or chat (e.g., BlogWise®). Example semi-public sources include, subscription news sources (e.g., Factiva®, Thomson®, Hoovers®, Wall Street Journal®) and example private sources include personal e-mail (e.g., Outlook®, Notes®), databases (e.g., SQL®, Lotus Notes®), group folders (e.g., shared drives), and/or personal folders (e.g., “My Documents”). It will be readily apparent to those of skill in the pertinent art from the present disclosure that any of a variety of other information sources equally may be used.

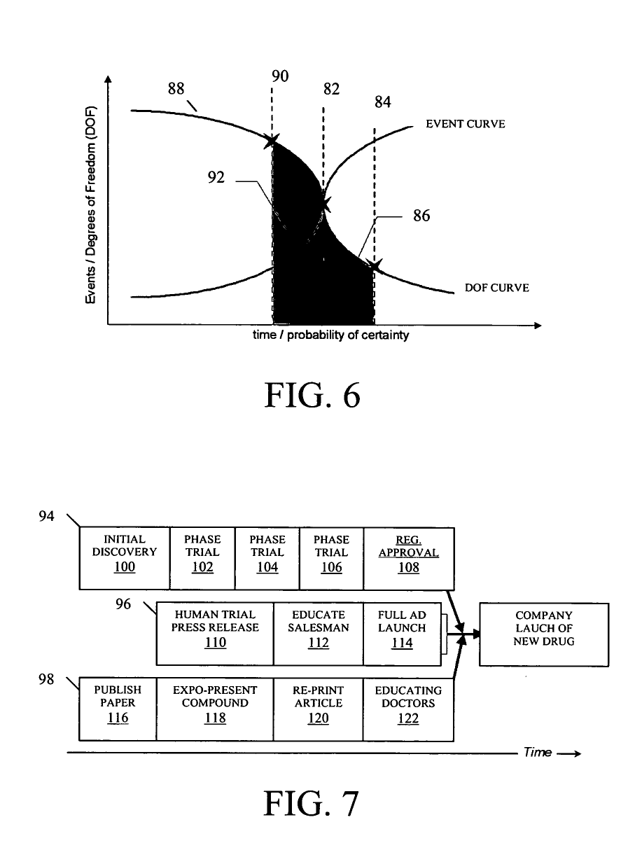

Turning now to FIGS. 6 to 8, in a preferred aspect of the present disclosure, the application 10 allows users to predict events, and more particularly business related events. As demonstrated by FIG. 6, as the number of preparatory events increases over time towards an action horizon, the degrees of freedom (DOF) to act decreases while the probability or certainty of the action occurring increases. Hence, there is a trade off between waiting for enough events to occur (i.e., the probability of action to increase) and the decrease in the DOF to act. Typically there is a lag between an action (indicated by line 82) and the public becoming aware of the action (indicated by line 84). An increase in the speed of information decreases the lag time and thus improves the DOF to act in response to the action by the area 86 under the DOF curve 88 between line 84 and the action line 82. However, there is also a distance between what is private awareness (indicated by line 90) and the action line 82. That is, there is a lag between the time the decision makers decide to take action and the action itself. As shown, the DOF can again be increased by modeling so as to predict the private awareness horizon. In fact, the area 92 under the DOF curve 88 between line 90 and the action line 82, which reflects the accurate prediction benefit, is far greater than the simpler area 86 reflecting the faster alert benefit. According to a preferred aspect of the present disclosure both benefits are captured.

By way of illustration, consider the drug industry. Prior to a new drug being launched companies must plan and expend time and resources along at least three tracks, a scientific preparation track 94, a marking preparation track 96, and a medical affairs preparation track 98. As shown in FIG. 7, the scientific preparation track 94 includes a discovery step 100 in which a novel compound is discovered typically as a by-product of research and development, a number of intermediate phase trial steps 102, 104, 106 proving the safety and efficacy of the new drug to regulators, and a final step 108 of gaining regulatory approval. The marking preparation track 96, for example, might include an initial step 110 of making a human trial press release, an intermediate step 112 of educating/training a sales force, and a final step 114 launching the new drug. The medical affairs preparation track 98 can include an initial step 116 of publishing a paper about the newly discovered compound, intermediate steps 118, 120 of presenting the new compound at an Expo and providing doctors with reprints of the published article, and a final step 122 of conducting doctor education meetings. The goal of the medical affairs preparation is to convince medical professionals of the scientific merits of the new drug.

Each preparatory step along the preparation tracks 94, 96, 98 either happens or it does not. Should a step happen, it is typically recorded and known publicly. If all the steps happen the probability of the new drug launch is 1. If none of the steps happen then the probability of the new drug launch is 0. Hence, the probabilities between 0 and 1 are dependent on the number of observed steps. The probability of a drug company's action (i.e., the launch of a new drug) with their preparatory steps can be modeled as follows:
S(1)+S(2)+S(3)+ . . . S(X)=P(A)
where S is preparatory steps, A is the action intended by the preparatory step, and P is the probability of the action.

The quality of the input of the model is dependent on correctly identifying preparatory steps in text (structured and unstructured). Accordingly, in a preferred aspect of the present disclosure, subject-verb-object (SVO) computational linguistics is employed to look for subject-verb-object in any form of text in any sentence construction. This SVO feature depends on not just identification of words but understanding the direction of the action represented in the sentence. In essence, the SVO detection correctly interprets the direction in addition to locating the “actors” in the sentence and answering the generic question “who is doing what to whom”. Additional entities such as time and place can be extracted as well so as to supplement the where and when aspects of the action. Thus, information processed according to the present disclosure is preferably relied on as input to a discrete choice model which estimates the probability of a future company action. This approach is beneficial at least in that the input for such predictions is raw text, which has the effect of improving the quality of the output.

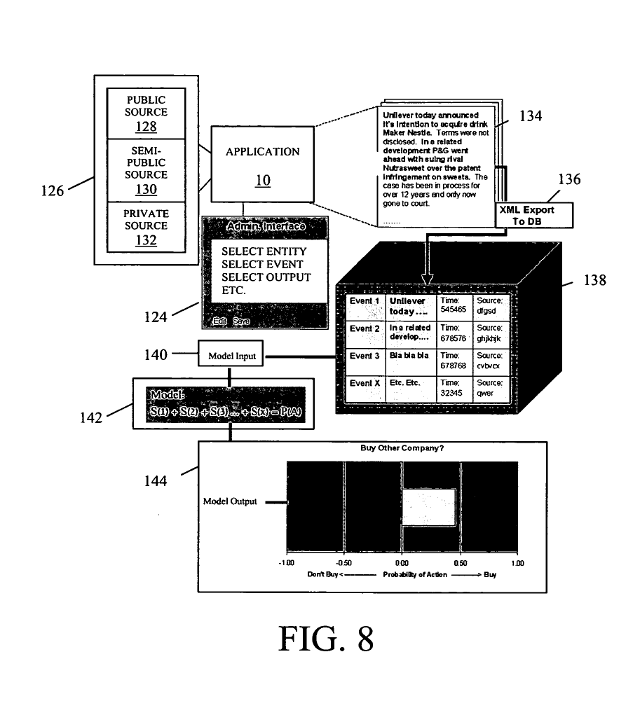

An exemplary architectural view illustrating the foregoing discussion is shown in FIG. 8. As shown, a query is made (box 124) whereby one or more events may be defined. A search is conducted (box 126) among a number of different information sources 128, 130, 132. Data collected from the various information sources is provided to the application 10 so as to be analyzed (box 134) via a plurality of passes identifying relevant information and transforming such information into a raw text format. The relevant information is exported (box 136) in, for example, an XML format to a database (e.g., a relational database) (box 138). The relevant information may then be used as input (box 140) for a prediction model (box 142) and thereby improve the quality of output (box 144).

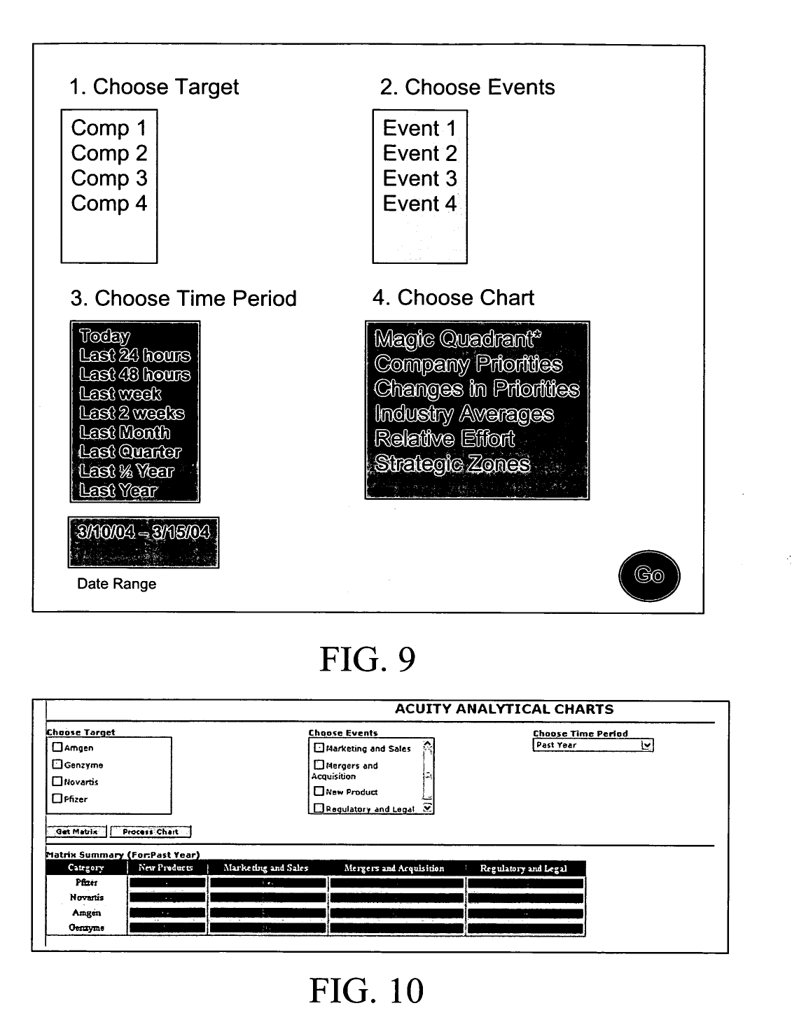

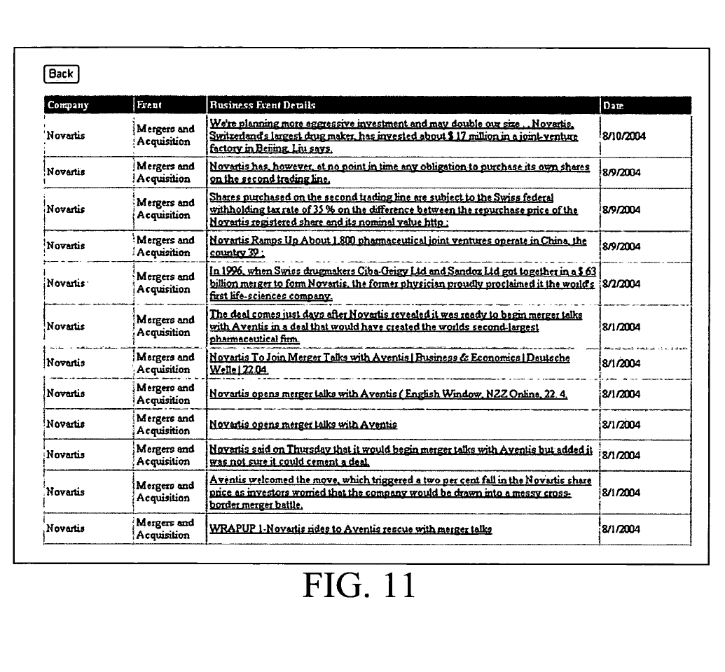

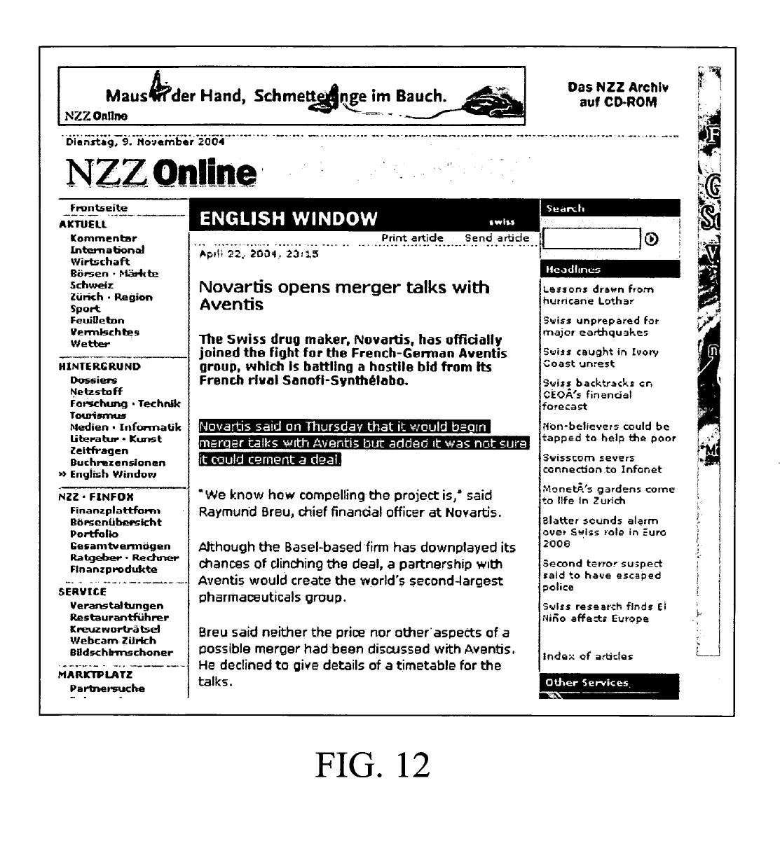

Turning to FIGS. 9 through 12, in addition to predictive functionality described above, in preferred aspects of the present disclosure, a variety of additional functionalities may be provided. For example, as shown in FIG. 9, in one aspect of the present disclosure, a user can define an input query using a number of predefined parameters (e.g., target type, event type, time period, etc.). Thus, the user may tailor the results by selecting the entity or entities, events, timeframe, relevancy or tolerance, and the like that are of interest. For example, as shown in FIG. 10, the results may be provided in a matrix summary taking into account multiple input factors. Also, as shown in FIG. 11, the results can be provided in the form of a hit list of hypertext links that may be sorted or ranked according to predefined descriptors. Still further, as shown in FIG. 12, the results may also be individually displayed with the relevant text highlighted for easy reference. It should be understood that the results may be provided in any of a variety other ways suitable to provide the user with effective and efficient means for evaluating and/or otherwise using the information.

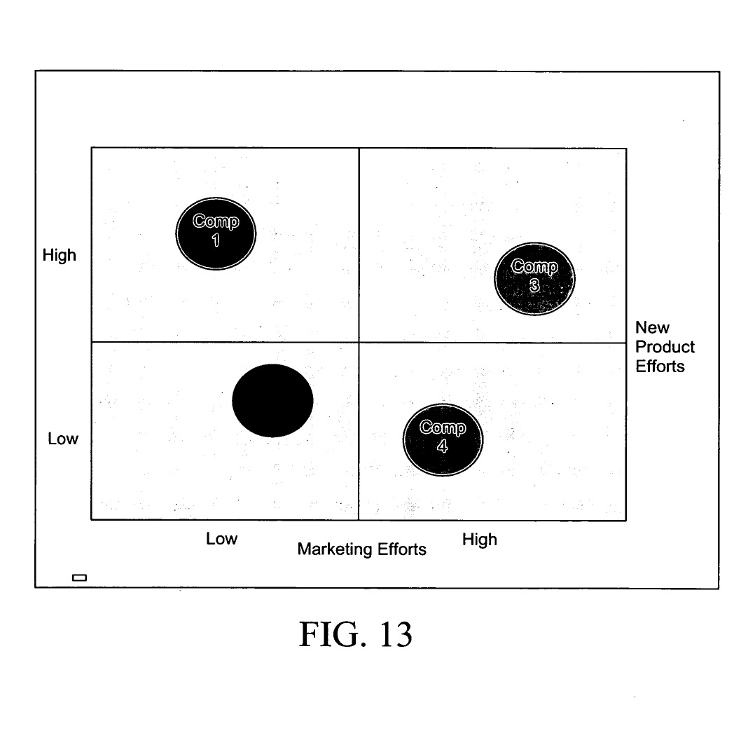

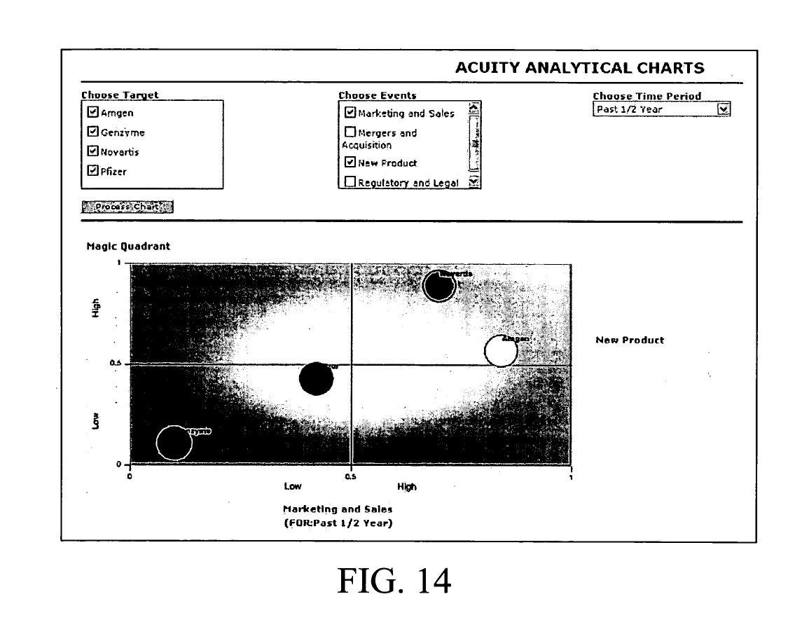

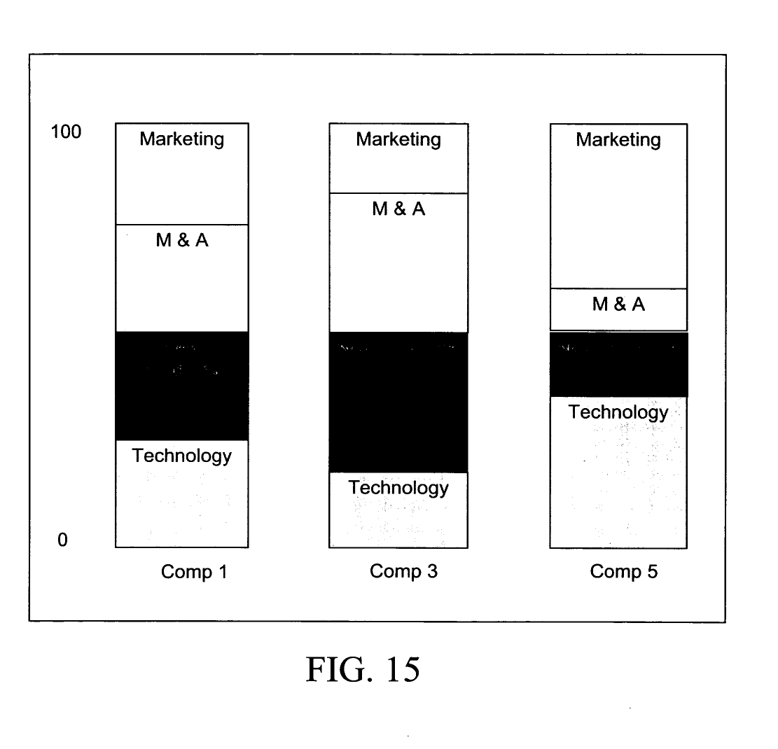

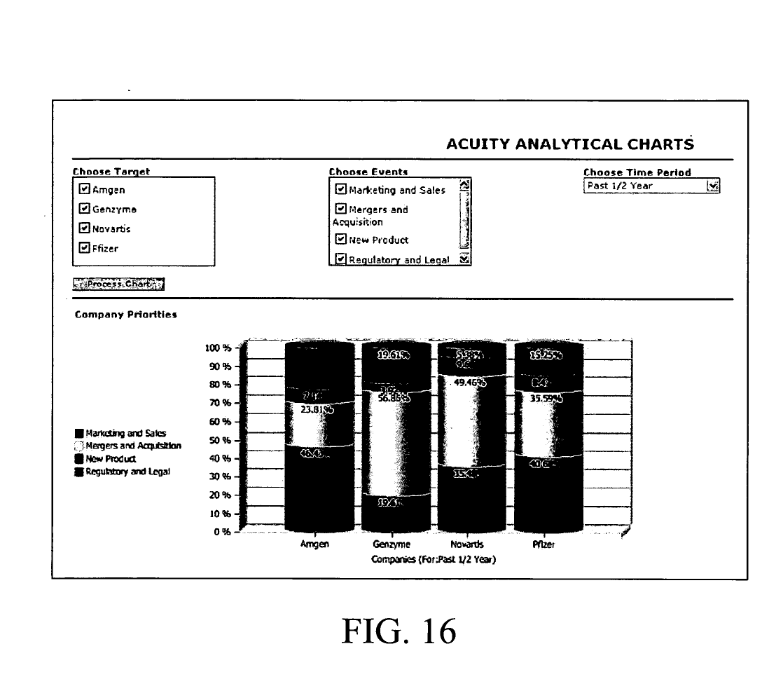

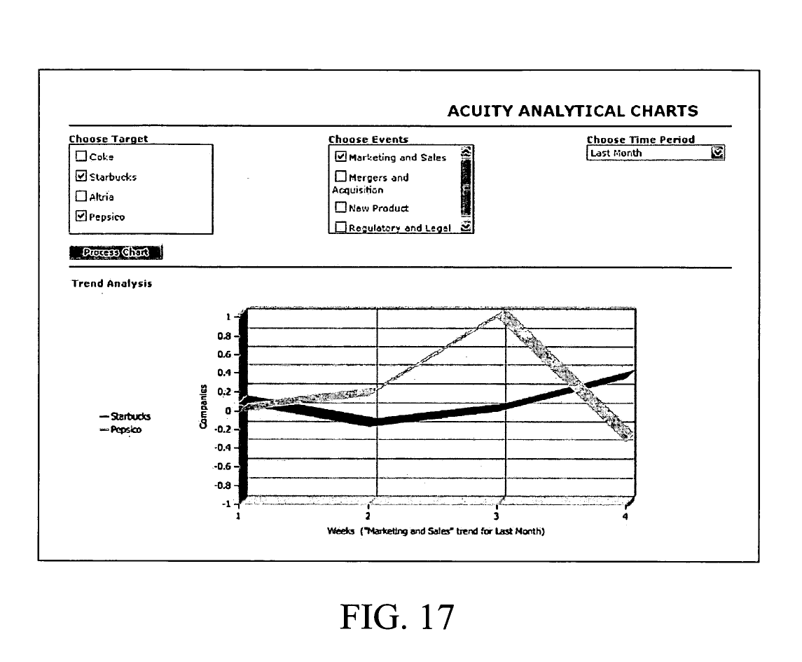

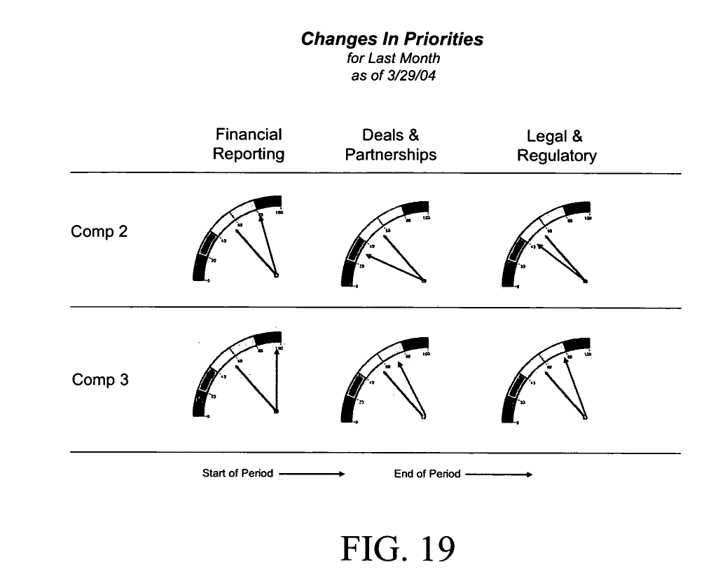

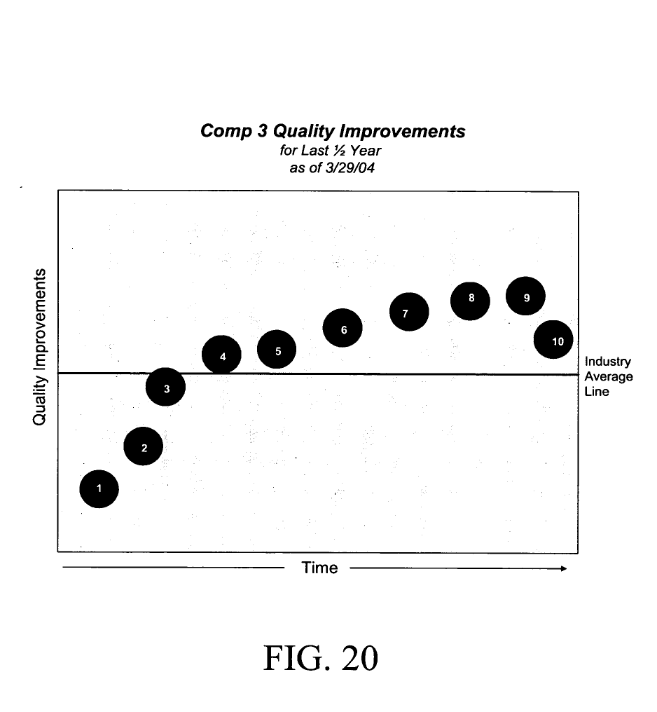

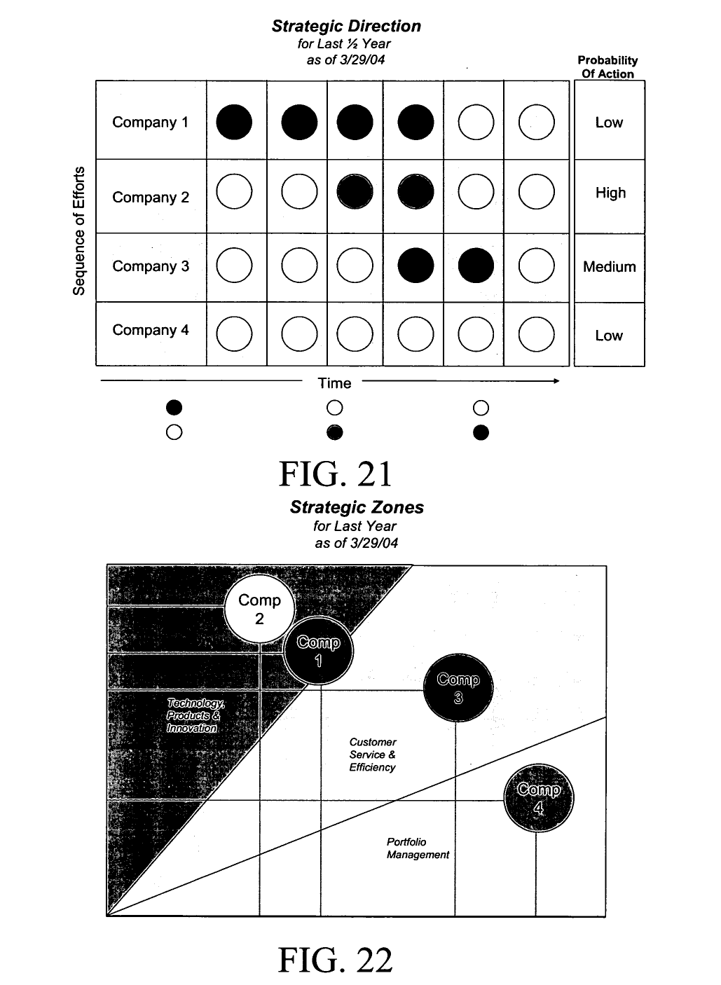

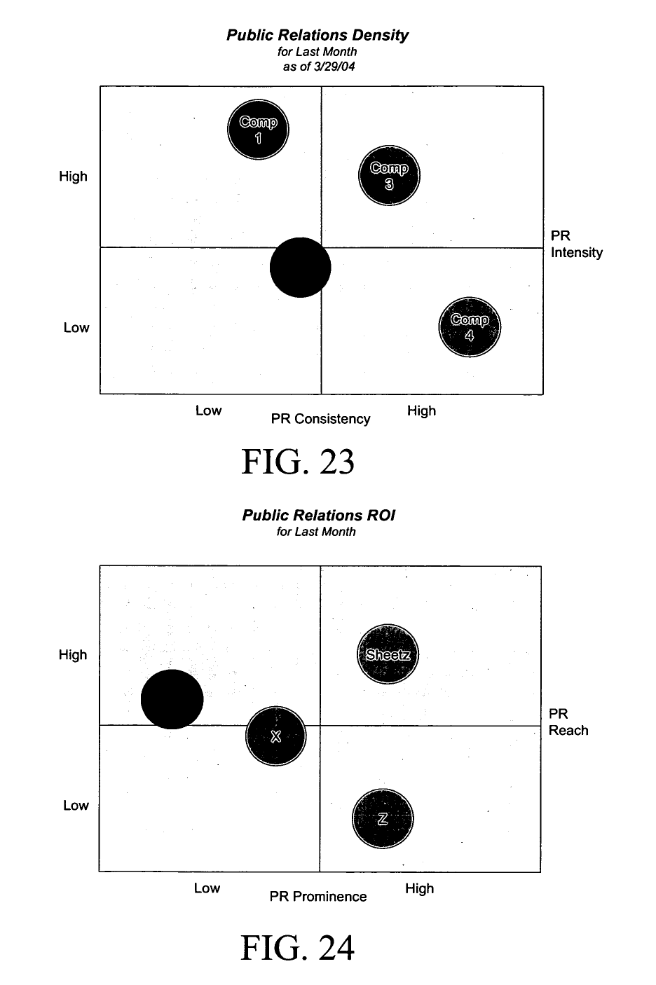

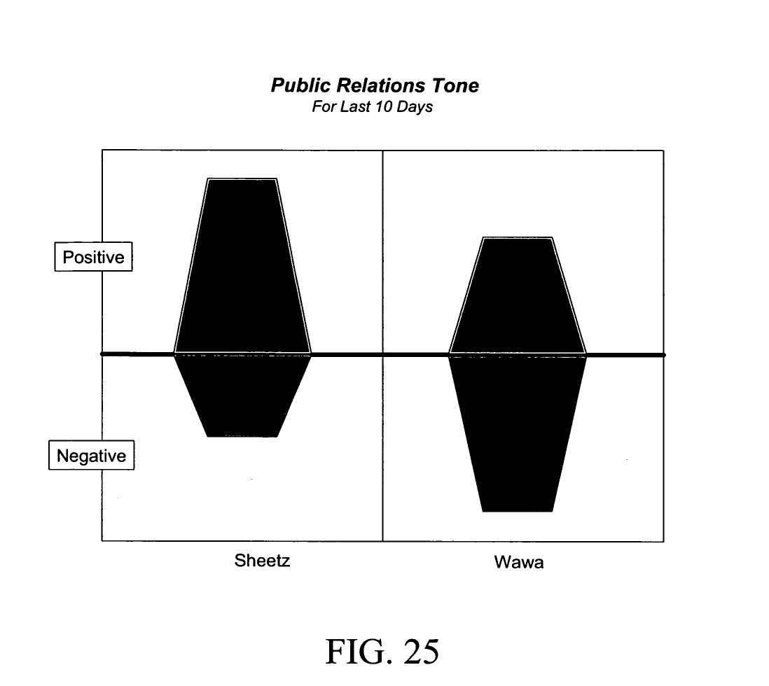

With reference to FIGS. 13 through 25, in accordance with still another preferred aspect of the present disclosure, a variety of different outputs may be accomplished. For example, as shown in FIG. 13, relevant output pertaining to one or more companies can be relatively charted according to predefined parameters (e.g., marketing efforts, new product efforts, timeframe). FIG. 14 is an exemplary screen display showing the relative space for four exemplary pharmaceutical companies (i.e., Amgen, Genzyme, Novartis, and Pfizer) demonstrating the degree to which such companies couple “New Products” with “Marketing and Sales” over a six month period. As shown, Amgen and Novartis, for the selected time frame, seem to support product launches with marketing and sales, whereas Pfizer and Genzyme appear to do notably less of such coupling. Additionally, as shown in FIG. 15, relevant output pertaining to one or more companies can be proportionally charted according to predefined parameters (e.g., marketing, M&A, new products, technology, timeframe). FIG. 16 is an exemplary screen display showing the proportion of effort for the four exemplary pharmaceutical companies as they execute in the marketplace over a six month period demonstrating how the companies have opted to allocate their resources to generate profits. Also, as shown via the exemplary screen display of FIG. 17, relevant output pertaining to one or more companies can also be trended over a defined period according to at least one selected parameter (e.g., marketing and sales, timeframe).

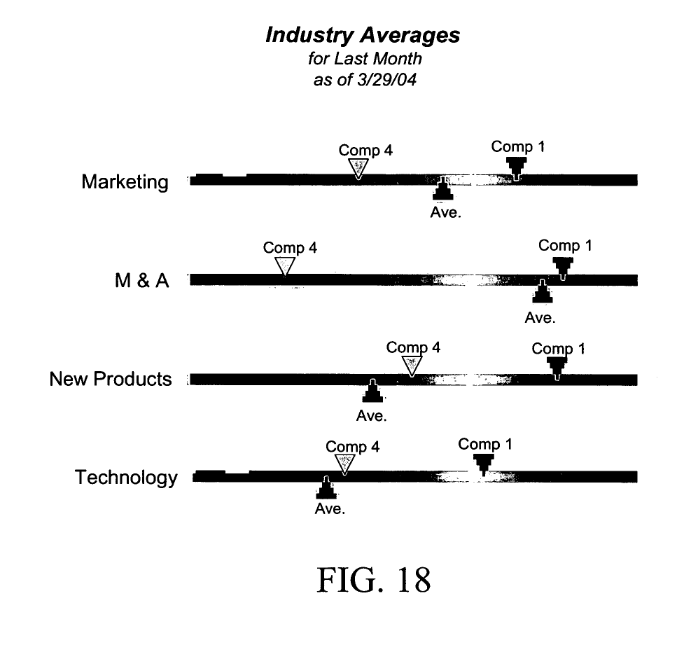

It will be readily apparent to one having skill in the pertinent art from the present disclosure that any of a variety of additional and/or alternative outputs equally may be provided and fall within the scope of the present disclosure. For example, as demonstrated via FIGS. 18-25, industry averages, priority changes, quality improvements, strategic direction and zoning, and/or public relations density, tone and ROI may equally be provided in a variety of different forms. In addition, any of the above-described output charts and/or graphs may be interactive so as to allow the user to modify the output and/or obtain more detailed information with respect to the displayed data (e.g., click on a charted line to obtain confirming details/information). Also, any of a variety of other conventional data manipulation tools (e.g., Word®, Excel®, Power Point®, etc.) may be integrally associated with the application of the present disclosure so as to facilitate providing relevant output.

While various preferred embodiments and/or implementations of the present disclosure have been illustrated and described, it is to be understood that the present disclosure is not limited to such exemplary embodiments and/or implementations. Rather, the present disclosure encompasses embodiments and implementations that fall within the spirit and scope of the present disclosure, including modifications, changes and/or enhancements that will be apparent to persons skilled in the art based on the foregoing disclosure.

1. A system for transforming unstructured text comprising:
means for defining a search query;
means for searching a plurality of information sources to collect data relevant to said search query;
means for processing said collected data so as to identify and transform unstructured text into structured text;
means for reporting results to an end user; and
means for storing results for reuse.

2. The system of claim 1, wherein said means for defining a search query is a computer based user interface with both information input and information output capability.

3. The system of claim 1, wherein said information sources include public sources, semi-public sources, and private sources.

4. The system of claim 1, wherein said means for processing collected data includes a computer program application using computational linguistics to look for subject-verb-object (SVO) in any form of text in any sentence construction.

5. A method for performing event analysis comprising the steps of:
(i) defining at least one event;
(ii) searching a plurality of information sources including unstructured text sources;
(iii) collecting data from said information sources;
(iii) processing said collected data using a plurality of passes;
(iv) identifying occurrences of said event;
(v) analyzing identified occurrences of said event; and
(vi) generating output based on relevant information pertaining to said event.

6. The method of claim 4, wherein said event is a business related event.

7. The method of claim 5, wherein said step of defining at least one event includes:
(a) selecting at least one target company;
(b) selecting a time period; and
(c) selecting at least one event type.

8. The method of claim 7, wherein said event type is selected from a group consisting of: merger, acquisition, marketing, sales, new product, research and development, regulatory and legal.

9. The method of claim 5, wherein said plurality of information sources include public, semi-public and private sources.

10. The method of claim 5, wherein said passes are selected from a group consisting of tokenizing, initializing, converting sub-trees to prose-like strings, resolving company names, setting XML tags, tagging white spaces, setting regions, marking HTML tags, removing HTML tags, identifying entities, tokenizing domains, reducing text, marking common entities, converting time, marking common terms, converting numbers, recognizing simple events, marking copyrights, marking headlines, extracting business entities, revising the knowledge base, generating and unifying metadata, categorizing companies, building causal phrases, correcting abbreviations, preparing event sentences, categorizing events, sub-segmenting information into output chosen by an end user, outputting a report to XML, and consuming XML.

11. The method of claim 10, wherein said output report is stored in a relational database for reuse.

12. The method of claim 5, wherein said step of generating reports is automatic.

13. A computer program application for causing a computer system to perform a method for transforming unstructured text, said computer program application comprising:
(i) an identifying feature for finding one or more defined events in various sources of information;
(ii) an analyzing feature for analyzing identified events so as to filter out extraneous information;
(iii) a transforming feature for reducing any form of text in any sentence structure to subject-verb-object; and
(iv) an output feature for outputting said identified events in a manner prescribed by an end user.

14. The computer program application of claim 13, wherein said various sources of information are selected from any one or more of a group consisting of public sources, semi-public sources and private sources.

15. The computer program application of claim 14, wherein said public sources include Internet sources, news sources, science sources, legal sources, government sources and chat sources, said semi-public sources include subscription sources, and said private sources include personal e-mail, networks, databases, group folders, and personal folders.

16. The computer program application of claim 14, wherein said output feature allows said end user to count, graph, chart, model and predict said events.

17. A method for predicting an event comprising the steps of:
(i) inputting a query defining at least one event;
(ii) conducting a search among a number of different information sources;
(iii) collecting data from said information sources;
(iv) providing said data to a computer program application employing computational linguistics to identify subject-verb-object in any form of text in any sentence construction;
(v) analyzing said data via a plurality of passes so as to identify relevant information and transform said relevant information into a raw text format;
(vi) exporting said relevant information to a database so as to be usable as input for a prediction model for predicting the probability of said event.

18. The method of claim 17, wherein said computational linguistics accounts for both word identification and sentence direction.

19. The method of claim 17, wherein entities such as time and place are extracted form said data so as to supplement where and when aspects of the event.

20. The method of claim 17, wherein said prediction model is a discrete choice model.

21. The method of claim 17, wherein text and sentence construction are English based.
